(19) United States
(12) Patent Application Publication
(10) Pub. No.: US 2014/0230519 A1
(43) Pub. Date: Aug. 21, 2014

(54) METHOD FOR CORRECTING OFFSET DRIFT EFFECTS OF A THERMAL MEASUREMENT DEVICE, THERMAL MEASUREMENT DEVICE AND GAS FLOW METER

(71) Applicant: HYDROMETER GMBH, Ansbach (DE)

(72) Inventors: Thomas KLEINER, Fislisbach (DE); Philippe PRETRE, Dattwil (DE); Andreas KEMPE, Zurich (CH); Hans-Michael SONNENBERG, Ansbach (DE)

(73) Assignee: HYDROMETER GMBH, Ansbach (DE)

(21) Appl. No.: 14/260,472

(22) Filed: Apr. 24, 2014

Related U.S. Application Data
(63) Continuation of application No. PCT/EP2012/004416, filed on Oct. 22, 2012.

(30) Foreign Application Priority Data
Oct. 24, 2011 (DE) 102011116698.3
Dec. 23, 2011 (DE) 102011122255.7
Jan. 20, 2012 (DE) 102012001060.5

(51) Int. Cl. G01K 15/00; G01F 25/00

(52) U.S. Cl. CPC G01K 15/005; G01F 25/0053
USPC 73/1.16; 374/1

(57) ABSTRACT

A method for correcting offset drift effects of a thermal measurement device (10) which comprises at least one temperature sensor (15a, 15b) arranged at a defined distance from a heating device (12) for a fluid to be measured, for measuring at least one measurement variable describing the temperature and/or temperature profile during operation of the heating device (12), in which a reference measured value (35) is measured at a reference time in a first measurement of the measurement variable with the heating device (12) turned off, in which a drift measured value (36) is measured at at least one later time in a second measurement of the measurement variable with the heating device (12) turned off, and in which a drift correction is carried out during the measurement by using the heating device (12) on the basis of a difference between the drift measured value (36) and the reference measured value (35).

The invention relates to a method for correcting offset drift effects of a thermal measurement device which comprises at least one temperature sensor arranged at a defined distance from a heating device for a fluid to be measured, for measuring at least one measurement variable describing the temperature and/or temperature profile during operation of the heating device. In addition, the invention relates to a thermal measurement device and a gas flow meter.

The principle of thermal measurement devices, which are particularly implemented as microthermal measurement devices, is already known in the prior art. It is based on the fact that a fluid, in particular a gas, is heated in a defined fashion via a heating device. Provided at a permanently defined distance from the heating device is a temperature sensor which, in a final analysis, measures the effects of the heating process under the currently existing conditions. Such thermal measurement devices are frequently applied to measure throughflow for gases. Provided for this purpose are two temperature sensors which are respectively arranged equally spaced on opposite sides of the heating device, that is to say one temperature sensor is provided upstream, while the other is provided downstream. If now, for example, there is no throughflow, the heat generated by the heating device is transported uniformly in both directions such that no temperature difference should be measured. However, if the gas flows off at a specific rate over the arrangement, there is set up at the temperature sensors a temperature difference which can be assigned to a specific throughflow via a characteristic. In this case, the final desired measurement variable is thus the difference between the sensor signals of the two temperature sensors of the same kind, which therefore represents a measure of the current temperature difference.

However, it is also known to consider other measurement variables, for example, a time-related sensor signal of a single sensor or the time profile of a single sensor signal at a time when the fluid is not moving since this represents a measure of the heat transfer, and therefore of the thermal conductivity of the fluid. Consequently, it is also possible in this way to determine the gas type in a gas flow meter, for example.

As already mentioned, such thermal measurement devices are frequently also implemented as microthermal measurement devices in the case of which all the relevant components can be provided on a single chip. For example, to this end the heating device can comprise a heating conductor strip, in which case it is possible to implement the temperature sensors as, if appropriate, a whole row of thermocouples provided equally spaced next to the heating conductor. Such measurement devices can be implemented with extremely small dimensions, for example, to the order of magnitude of a rectangular chip with side lengths in the range of 2-5 mm. For example, the temperature sensors and the heating device can be provided on a silicon nitride membrane part of a printed circuit board which includes a control device and the like in the region of the silicon bulk component of the evaluation electronics.

As already mentioned, such thermal measurement devices, in particular ones that are implemented as microthermal measurement devices, are frequently used in electronic gas flow meters, for example, gas meters, which are therefore intended for measuring the volume flow of a gas. However, it has emerged from the practical use of such measurement devices that the offset of the measurement signal is not sufficiently stable to ensure a clean zero point for the measurement variable in the case of zero throughflow (or another reference throughflow). In the extreme case, it can happen here that a gas flow meter measures a throughflow when there is in fact none.

Normally, thermal measurement devices which are used to measure throughflow or the like are firstly calibrated such that a measured zero throughflow corresponds to a zero throughflow of the characteristic in order that the latter can be applied. In order to examine the problem of the offset, it has been proposed in the prior art to store the thermal measurement devices after calibration for a specific time interval, for example several weeks, in which case after said time and/or before delivery, the throughflow offset is determined once again in order to ensure said offset remains stable within prescribed limits. However, this method for determining the offset behavior by means of only two measurements at different times must be assessed as rather unreliable.

What is chiefly problematical regarding the observed offset drift effects is that the offsets do not drift continuously, in which case it would be conceivable to make a forecast or the like, but usually fluctuate within a restricted band. It is therefore also known to define such a band, meters which lie within this band in the second offset determination as a one-shot display being able to be specified as “good”, whereas meters that lie outside a specified band as “poor”. However, long term measurements have shown that in individual cases the offset can still begin to drift even after a lengthy time interval. It follows not the known procedure has the consequence that, firstly, not all unsuitable thermal measurement devices are filtered out and, secondly, that even measurement devices which could be used per se without any problem are rejected.

It is therefore an object of the invention to specify a method for monitoring the offset drift in thermal measurement devices of this type, and of employing a real time correction.

In order to achieve this object, it is provided according to the invention in a method of the type mentioned at the beginning that a reference measured value is measured at a reference time in a first measurement of the measurement variable with the heating device turned off, in that a drift measured value is measured at at least one later time in a second measurement of the measurement variable with the heating device turned off, and in that a drift correction is carried out during the measurement by using the heating device on the basis of a difference between the drift measured value and the reference measured value.

A measurement cycle of a thermal measurement device of this type is usually provided such that initially the heating device is activated for a specific period, for example 100 ms in the case of a microthermal measurement device. After a certain preheating time after which a stable state prevails, the actual measurement of the measurement variable then takes place, a measurement after deactivation of the heating device usually no longer yielding significant measured values. The invention is based on the idea of using as reference a measurement which is subjected to the same parameters as the actual measurement of the measurement variable: that would be a measured value at zero throughflow in the case of throughflow measurement as principle field of application. However, it is a problem here that it is never possible to establish exactly whether the throughflow is actually zero so that it has been detected according to the invention that this state can be approximately simulated by not switching on the heating device when taking a measurement. This means proposing in accordance with the invention to use for the correction an additional measurement cycle in which the heating device is not operated and therefore no use has been made of the heating device, but otherwise the measurement conditions remain exactly the same. Consequently, the same measurement path, in particular the same multiplexers and/or the same amplifiers and/or the same ADC settings, are used as are used in the thermal measurement device for the actual measurement with the heating device switched on.

In particular, it can thus be provided to determine the measurement variable by using an electronic module, in particular comprising an amplifier and/or an analog-to-digital converter for digitizing the measurement variable, from signals of the temperature sensors. The inventively proposed correction therefore directly advantageously starts with the digitized measurement variable which means that the offset drift is determined with the aid of the digitized measurement variable, and therefore also detects effects which stem from components of the electronic module, for example from a multiplexer, an ADC, an amplifier and/or other components.

It has been found in investigations by the inventors that interference sources responsible for the drifting offset are multifarious. Effects influencing the offset drift are to be sought at the temperature sensors, the multiplexers, amplifiers, analog-to-digital converters (ADC) as well as the power supply. If, as is provided according to the invention, the thermal energy input via the heating device is suppressed while nothing is changed in the remaining course of the measurement, constant temperature signals independent of flow are expected, in particular. If a drift now occurs in the overall system with the passage of time, however, without energy input by the heating device the temperature signals will trace this drift in turn, particularly independently both of flow and of gas type, such that it is possible to determine such a drift by tracking the signals and/or the measurement variable determined therefrom at a time t by comparison with the reference time, in each case with the heating device switched off, and to correct the measured value of actual interest with the heating device switched on with said determined drift, for example a correction value.

Thus, according to the invention the offset drift of a thermal measurement device is compensated by tracking the measurement variable with the heating device switched off, and making use of a difference occurring relative to the reference time, the difference between the reference measured value and the drift measured value, in order to correct the measured values of the measurement variable with the heating element switched on (or at least the evaluation variable ultimately being sought). Since, with the heating device switched off, the temperature signals are not influenced by the flowing or stationary fluid, the true system drift is hereby displayed.

It may be noted at this point that many known thermal measurement devices already have an inherent capability, in particular through use of suitable multiplexers, to output various measurement variables and use them in parallel. For example, in an arrangement of temperature sensors provided at opposites sides of the heating device, it is possible through an appropriate setting to set the multiplexer to consider the sum of the signals of the temperature sensors, the individual signals of the temperature sensors and the difference between the signals of the temperature sensors as measurement variables, it being possible, for example, to consider the difference with reference to a throughflow measurement and to consider the individual signals with regard to determining fluid type, in particular determining gas type. Correspondingly, the inventive method can, of course, also be used to correct a plurality of measurement variables or evaluation variables with reference to an offset drift of the overall system. The method is therefore applicable to a plurality of measurement variables, including from a single thermal measurement device.

In an advantageous embodiment of the present invention, it can be provided that the second measurement is carried out cyclically at predetermined time intervals, in particular in the range from every 5 minutes to every 24 hours. In a cyclic repetition of the second measurement, it can be achieved that there is always a drift measured value representing as current an offset drift as possible. It is to be taken into account here that the offset drift is a phenomenon occurring on lengthy time scales, for example, a development can extend over weeks. Depending on the time scale ultimately to be taken into account in the particular thermal measurement device, it can correspondingly be expedient to record drift measured values every 8 minutes, every 5½ hours or every 24 hours, for example, with other time intervals between the second measurements also being conceivable.

In a particularly advantageous embodiment of the present invention, it can be provided that during the correction use is made of a mean value of drift measured values recorded in the second measurements following one another in up to the last performed, second measurement, in particular a sliding mean value and/or a mean value from 30 to 80 individual drift measured values. The use of a mean value is particularly advantageous to the effect that noise effects, statistical measuring errors and the like can be filtered out, and a more accurate estimate of the actual drift results. It is expediently possible here to provide a sliding mean value that is always kept current. For example, it is conceivable always to average the 64 last drift measured values in order, for the purpose of forming the difference, to subtract therefrom the reference measured value, which value, in any case, may also be a mean value from a plurality of measurements, so as to obtain a correction value.

As has already been indicated, it is customary with such thermal measurement devices that in order to calibrate the position of a characteristic diagram containing evaluation characteristics combining the measurement variable with an evaluation variable to be determined, at a first time a measurement is carried out with the use of the heating device in order to determine a basic calibration value to be subtracted from the measured values, or to be used to shift the evaluation characteristics, in particular in such a way that when measuring throughflow a zero crossing of the evaluation characteristic occurs at zero flow. What is involved here is the basic calibration of the thermal measurement device, which is known in principle from the prior art.

It is also possible in principle to carry out the inventive method as described so far, this being offered chiefly for thermal measurement devices which or for the sensors of which, do not have a particularly strong temperature response. However, it can also happen that a relatively strong temperature response is provided. If, for example, when measuring throughflow consideration is given to the difference between temperature signals from the temperature sensors provided equally spaced apart opposite the heating device, cases can, nevertheless, occur in which various differences are supplied as signal in the case of different absolute temperatures but the same temperature difference. Consequently, the measurement variable representing the temperature difference differs with the heater switched on and a zero throughflow from that measured with the heater switched off since, for example, the temperatures at the temperature sensors are respectively lower by 10° C., for example.

It is already the case in the prior art that such temperature effects related to the fluid temperature can be forestalled, for example, by providing not a single characteristic relating the measurement variable to the throughflow, but an entire characteristic diagram, and by continuously detecting the temperature of the fluid via an additionally provided, further fluid temperature sensor, in particular the gas temperature sensor, and appropriately selecting a characteristic.

Whereas with reference to the present invention, it is possible in principle to assume that the actual offset drift is dependent entirely on temperature, it must nevertheless be taken into account for the determination of the offset drift that if the reference measured value has been recorded at a specific temperature problems can occur whenever the second measurement is carried out at a different temperature of the fluid.

In order to extend the correction with regard to this effect as well, these problems can be solved in accordance with the invention by providing that at the first time which corresponds to the reference time and at which there is no throughflow and/or a clearly defined fluid type, a basic calibration value is determined for a measurement with the use of the heating device as a reference measured value without the use of the heating device, this being done for at least two different fluid temperatures measured independently of the heating device by a fluidic temperature sensor, the plurality of reference measured values being taken into account for the correction in accordance with the temperature when the measured value is recorded. It follows, particularly as to the reference time, that a plurality of reference measured values are also recorded at different fluid temperatures, in which case it is not only that basic calibration values are determined for the measurement with heating device switched on, which are then used to be able to use evaluation characteristics of a characteristic diagram that combine the measurement variable with an evaluation variable, but, in addition, that a plurality of reference values are also determined for the measurement with heating device switched off such that it is ideally possible even to avoid effects owing to the temperature response for a temperature at which a measured value has been recorded with heating device switched off by going back to the reference for the same temperature or for a comparable temperature as well. Changes in the reference measured values recorded at different fluid temperatures indicate deviations which occur when the reference measured value has been determined, at another temperature, as the measured value with which the difference was formed. Ultimately, measurements are taken at various temperatures instead of a single reference measured value. Even a particular nonlinear temperature dependence of the measurement variable which leads to different reference measured values at different fluid temperatures is taken into account in this way.

In this way, for example, it can be provided that a temperature characteristic combining the basic calibration values and/or the reference measured values with the fluid temperature, and/or lookup table are/is determined and used to determine the basic calibration values and/or reference measured values and/or evaluation characteristics for a specific temperature. For example, it is possible here to work with interpolation, extrapolation and/or fits in order to determine the temperature characteristic or to determine a lookup table from which the appropriate value can then be taken for specific measured fluid temperatures.

As stated, the offset drift to be corrected corresponds to the difference between the reference measured value and the drift measured value. Several variants of the inventive method are now conceivable for compensating, in particular, directly or indirectly by this offset drift a particular measured value recorded during operation of the heating device, or which at least lead to a correct evaluation value of the evaluation variable. Of course, it is also possible to conceive modifications of the examples now shown, particularly specific procedures differing mathematically.

In a first embodiment, it can be provided that a correction value is determined as the difference between the drift measured value and the reference measured value and is subtracted from the measured value recorded with the use of the heating device. In this embodiment, the offset drift is determined explicitly as the correction value in order then to be applied to the measured value for the direct correction. Thereafter, the corrected measured value can then, as described above, be used, for example, as input value of an evaluation characteristic in order to determine an evaluation value of the evaluation variable. It is a particular advantage of this refinement that after the offset drift is determined explicitly it can be tracked and, if appropriate, be further evaluated, for example with reference to staying in a specific interval.

In an alternative second embodiment, it is possible, as described above, when determining a basic calibration value to modify the latter by subtracting or adding the reference measured value, the drift measured value being added to the measured value, recorded using the heating device, the drift measured value being subtracted from the measured value, recorded using the heating device, for the purpose of correction. The basic calibration value is fundamentally added to all recorded measured values, the invention in this case utilizing an already known procedure by modification of the basic calibration value. This means, however, that an explicit comparison of the drift measured value and the reference measured value no longer has to be performed, but that it suffices when the drift measured value is applied to the recorded measured value (already modified by the basic calibration value) counter to the modification of the basic calibration value. That is to say, when the reference measured value features positively in the recorded measured value the drift measured value is subtracted and vice versa, the result effectively being that, in a fashion easier to implement in specific environments, the recorded measured value is also corrected here by the difference between the drift measured value and the reference measured value, that is to say the drift offset.

A third embodiment of the inventive method provides that an evaluation characteristic—compare also the above embodiment—used to assign the measurement variable to an evaluation variable is shifted by the reference measured value, the measured value shifted counter to the shift direction by the drift measured value and recorded using the heating device being used as input value in order to determine an evaluation value. In this case, the drift measured value is thus once again added to the measured value, although the difference from the reference measured value is taken into account by the evaluation characteristic, which has been shifted counter to said reference measured value so that a corrective evaluation value of the evaluation variable is obtained by said implicit comparison. Moreover, it is possible in this case to provide that the evaluation characteristic is expanded so that it can also calculate negative flow values. A simplified implementation of the method is rendered possible.

In said embodiment, it is expedient when the evaluation characteristic is also shifted by the basic calibration value—compare the above statements—in the determination of a basic calibration value. This means that no modification of the measured value need be performed even for the basic calibration value, but said measured value is already displayed by the shifted evaluation characteristic. For the measured value which is to be evaluated and which has been recorded with an active heating device, it is then necessary merely further to apply the (current) drift measured value to find the correct evaluation value.

Furthermore, in this embodiment, it can be provided that a blocking region completely describing a zero throughflow is determined with the aid of the basic calibration value in the evaluation characteristic in the case of a measurement variable describing the throughflow of the fluid through a measurement channel containing the measurement device. It is possible in this way to avoid determining a throughflow value by measurement uncertainties in the zero throughflow. For example, if there is a value X for the basic calibration value, this means that the zero throughflow would be assigned in the shifted characteristic, for example, a measured value of X in the absence of an offset drift. Consequently, it is possible to define a blocking region, for example symmetrically [X−Y, X+Y], such that the zero throughflow is assigned to each of the values of the blocking region. The usual evaluation characteristic continues to be used outside the region.

It may further be noted that the statements relating to reference measured values, basic calibration values and characteristics for a plurality of temperatures can, of course, be applied to all these embodiments.

The inventive correction can be applied with particular advantage when a microthermal measurement device, particularly one implemented on a chip, is used as measurement device, and/or at least one thermocouple, in particular a number of series-connected thermocouples equally spaced from the heating device, are used as temperature sensor. In particular, it is possible to use an overall device which is implemented on a printed circuit board of bulk silicon, a silicon nitride membrane being contained on which the temperature sensors can be implemented as thermocouples and the heating device can be implemented as a heating conductor through which current can flow. A fluid temperature sensor, in particular a gas temperature sensor can, for example, additionally be provided as diode temperature sensor on the silicon bulk printed circuit board which simultaneously acts as heat sink and therefore receives the temperature of the fluid, in particular of the gas. An example of such a refinement of a thermal measurement device is the SF04 sensor from Sensirion AG, Switzerland.

As already stated, the present invention is preferably used for throughflow measurement. It can be provided in this case that a measurement variable describing the throughflow of the fluid through a channel containing the measurement device is measured as measurement variable, at least one temperature sensor being provided in a throughflow direction of the fluid on both sides of the heating device an equal distance from the heating device, and a difference variable between sensor signals of the two temperature sensors is used as measurement variable. The measurement variable therefore represents a local temperature profile, specifically the temperature difference.

It is preferably possible to provide additionally, or else alternatively that a measurement variable representing a static state of equilibrium, describing the thermal conductivity of the fluid, is measured as measurement variable after activation of the heating device and is used to determine a fluid type. In particular, when the intention is also to undertake a throughflow measurement with the thermal measurement device, it is possible, for example, to provide times at which it is checked whether the same fluid type, in particular gas type, is still present. It is possible to conceive refinements of the inventive method in the case of which such gas type determining measurements are carried out in parallel with second measurements, in particular the same cycle being used.

By way of summary, it is particularly advantageous when the thermal measurement device is installed in a gas flow meter.

In addition to the method, the present invention also relates to a thermal measurement device comprising a heating device, at least one temperature sensor arranged at a defined distance from the heating device for a fluid to be measured, for measuring at least one measurement variable describing the temperature and/or temperature profile during operation of the heating device and a control device which is designed to carry out the inventive method. All statements relating to the inventive method can be analogously transferred to the inventive thermal measurement device, whose control device is therefore designed to be driven appropriately so as to take the reference measurement and the at least one second measurement. Provided in particular to this end is a control option which enables independent activation or deactivation of the heating device.

Finally, the present invention also relates to a gas flow meter, in particular a gas meter, which comprises an inventive thermal measurement device. All preceding statements may also be transferred thereto. The thermal measurement device of the gas flow meter is therefore designed, in particular for throughflow measurement, and consequently has at least one temperature sensor, specifically therefore two temperature sensors, in a throughflow direction of the gas on both sides of the heating device at an equal distance from the heating device.

Other advantages and details of the present invention emerge from the exemplary embodiments described below and from the drawings, in which:

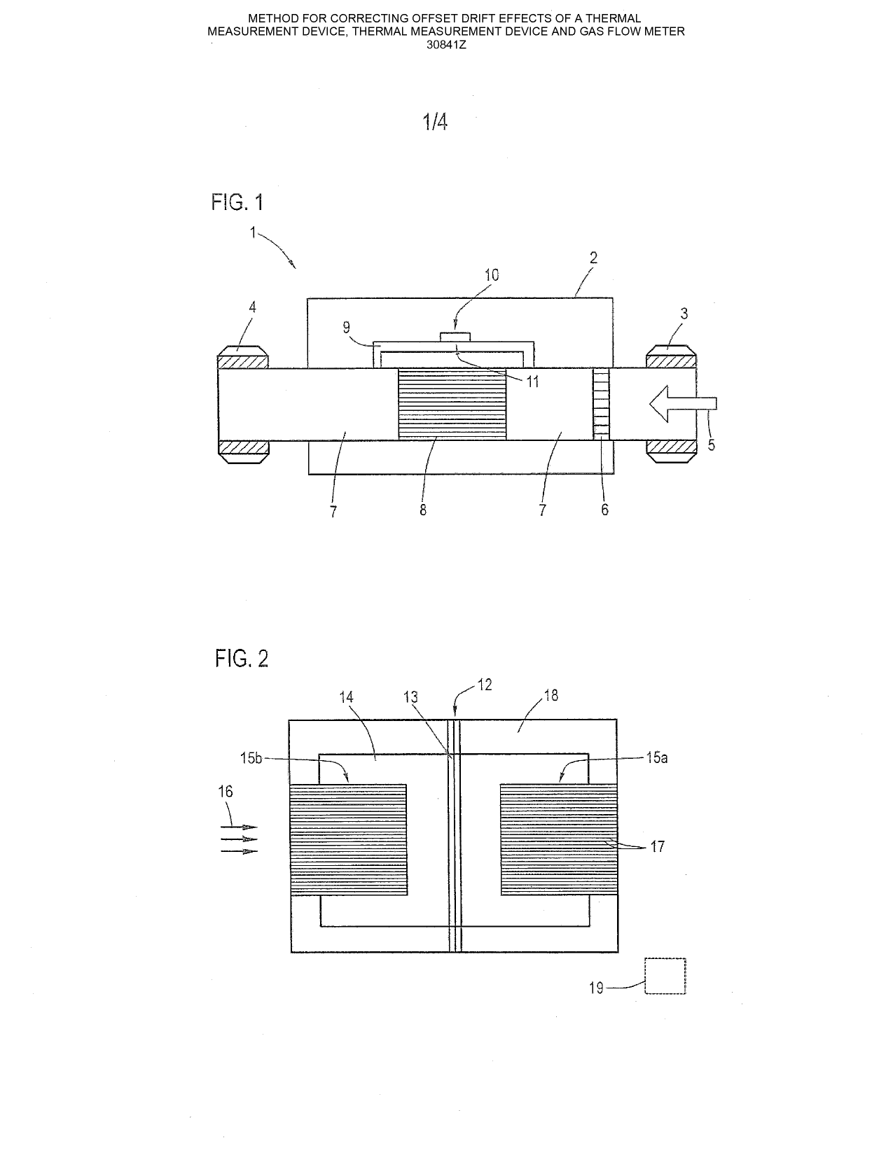

FIG. 1 is a schematic of an inventive gas meter,

FIG. 2 is a schematic of an inventive thermal measurement device,

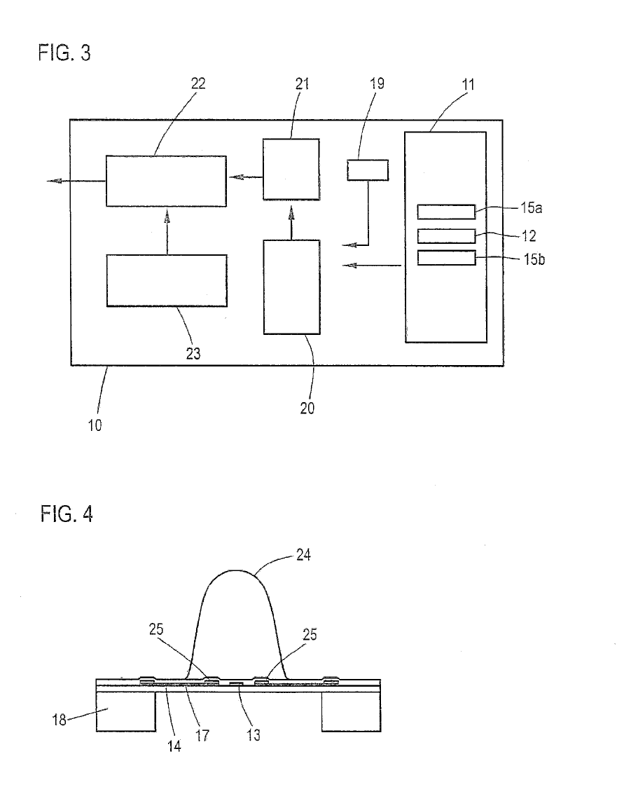

FIG. 3 shows a plan view of the measuring area of the thermal measurement device,

FIG. 4 shows a first illustration of the measuring principle,

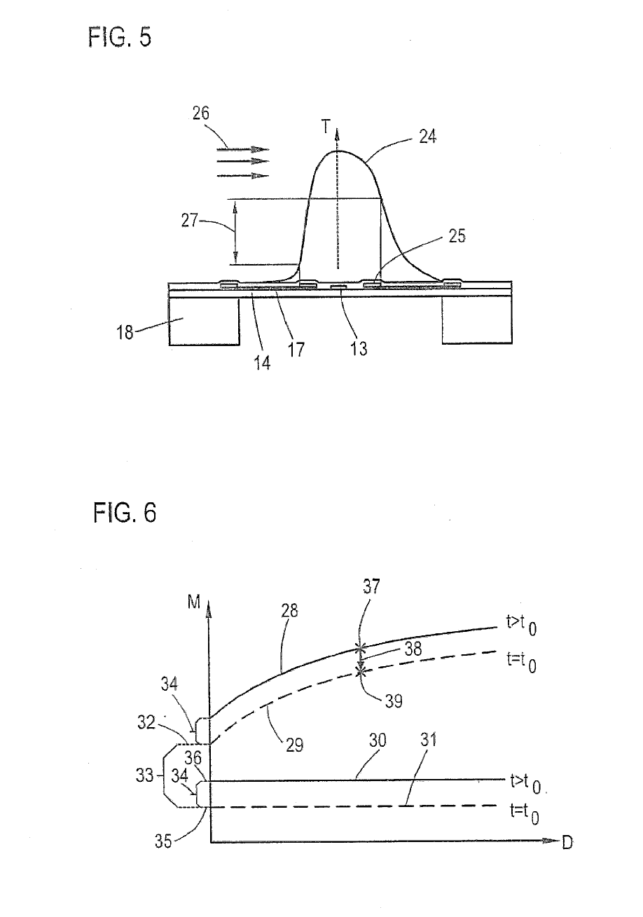

FIG. 5 shows a second illustration of the measuring principle,

FIG. 6 shows a graph for explaining the inventive method, and

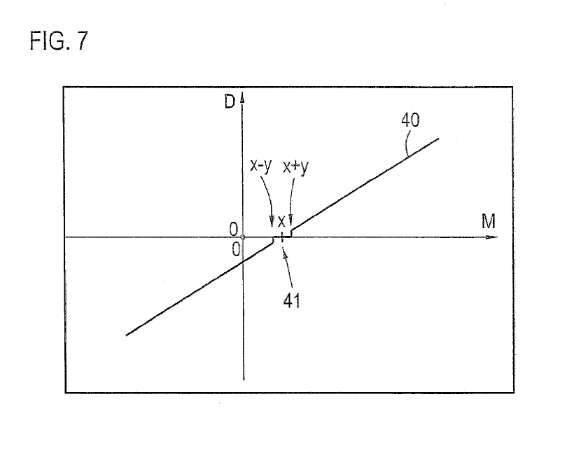

FIG. 7 shows a graph for explaining the third embodiment of the inventive method.

FIG. 1 shows a schematic of an inventive gas meter 1. As is known in principle, the latter has a housing 2 in which there are also integrated here a gas inlet 3 and a gas outlet 4. Via the gas inlet 3, the gas passes into a feed 6, in accordance with the inflow direction, arrow 5. The gas can, for example be swirled in order to extract particles from the gas flow. The actual throughflow measurement takes place in the region of the main channel 7, where a portion of the gas is led via a back pressure body 8 into a measurement channel 9 on which an inventive thermal measurement device 10, here provided on a printed circuit board, is arranged. The actual measuring area is denoted here by the reference symbol 11 and is extremely small, for example in the range of a few millimeters.

From the measurement channel, the gas passes back into the main channel 7 from where it is guided therefrom to the gas outlet 4.

Here, a wall of the measurement channel 9 is bounded by the printed circuit board of the thermal measurement device 10, the printed circuit board containing electronic components for processing measurement signals and measurement variables. The actual measurement components of the thermal measurement device 10 in the measuring area 11 are implemented in this case as a microchip which can be produced as a computer chip with the aid of semiconductor processes. Also integrated on the chip is a first control and evaluation electronics, and this renders precise throughflow measurements possible. The elements for the measurement which are provided in the measuring area 11 are embedded in a thin membrane made from silicon nitride, FIG. 2 showing a plan view of the membrane 14 with all essential components. A heating conductor 13 is provided centrally on the membrane 14 as part of a heating device 12. Series-connected thermocouples 17 are provided as temperature sensors 15a, 15b in the flow direction 16 on opposite sides of the heating conductor 13 at an equal distance from said number of series-connected thermocouples 17 such that the temperature propagation on the thin membrane 14 is measured by means of the temperature sensors 15a, 15b arranged symmetrically around the heating conductor 13. The rows of thermocouples 17, which can also be denoted as thermopiles can comprise 36 thermocouples 17 in each case, for example. The surrounding bulk silicon 18 acts as a heat sink, and it is possible to provide therein in a fashion clearly spaced apart from said measurement arrangement—only indicated in FIG. 2—a gas temperature sensor 19 designed, for example, as a diode sensor. The bulk silicon 18 is at ambient temperature, that is to say the gas temperature.

Components of the thermal measurement device 10 may be gathered from the schematic of FIG. 3. Thus, in addition to the components provided in the measuring area 11, in particular the temperature sensors 15a, 15b, and the gas temperature sensor 19, said device comprises an amplifier 20 and an analog-to-digital converter 21 (ADC), for the purpose of digitizing the measured values of the measurement variable. It may therefore be said in general that an electronic module for determining the digitized measurement variable is provided. Which measurement variables are actually being amplified and output by the amplifiers 20 and the ADC 21, is, in the final analysis, decided by multiplexers not illustrated in more detail here. It is possible in this case to output, in particular, a difference in the sensor signals of the temperature sensors 15a, 15b, as well as the individual signals of the temperature sensors 15a, 15b, the difference representing a measure of the temperature difference between the positions of the temperature sensors 15a, 15b and being evaluated for throughflow measurement, while at least one of the individual signals of the temperature sensors 15a, 15b can be evaluated in order to determine gas type.

The thermal measurement device 10 also comprises a control device 22 which is assigned a storage device 23 and which takes over both the driving of the components, and also first evaluation tasks, for example, the assignment of the measured value to a variable of interest, for example, in order to determine a throughflow from the difference between the sensor signals of the temperature sensors 15a and 15b.

The measurement principle for the throughflow measurement may firstly be explained in more detail once again with the aid of FIGS. 4 and 5. Here, FIG. 4 shows the situation at a zero throughflow. It is evident that a symmetrical temperature distribution 24 results when the heating device, heating conductor 13, is switched on. This means that the hot contacts 25 of the thermocouples 17 are at the same temperature, and so no temperature difference should be measured in ideal states. If a throughflow 26—FIG. 5—now occurs the temperature distribution 24 on the membrane 14 is shifted. Ahead of the heating conductor 13, upstream, the temperature drops more intensely than downstream in the direction of flow after the heating conductor 13. Consequently, it is possible to measure between the two temperature sensors 15a, 15b a temperature difference 27 whose amplitude and sign supply information concerning the speed and direction of flow.

With the aid of characteristic diagrams, which usually also consider the gas temperature, for example, can provide for different gas temperatures or gas temperature ranges different evaluation characteristics which combine a particular measured value, describing the temperature difference, with a throughflow value as evaluation value, and which can be stored in the storage device 23, it is possible to determine a throughflow value as variable of interest, it being possible, firstly, to calibrate the thermal measurement device such that the zero throughflow is ideally also respectively displayed at the zero crossing. To this end, at least one basic calibration value is measured for zero throughflow. Such calibration procedures are already known in principle in the prior art. Similar evaluation characteristic diagrams can be provided for determining the gas type.

The control device 22 is, however, also designed to carry out the inventive method, that is to say it is possible to undertake a correction of an offset drift such as can occur with the thermal measurement device 10. In this case, the inventive method may be explained in more detail here with regard to the throughflow measurement, by reference firstly to FIG. 6. Shown there for a specific gas temperature are the evaluation characteristics 28, 29, 30, 31 which combine the measurement variable, describing the temperature difference, with a throughflow variable, it being possible for the zero crossing to be situated at the point 32 after the calibration already described. The characteristics 29 and 31 relate to a reference time t₀. Here, the characteristic 29 relates to the relationship with the heating device 12 switched on, while the characteristic 31 shows the relationship with the heating device 12 switched off, where there is consequently a straight line of zero slope owing to the unchanged uniform temperature distribution. However, it can already be seen that between the characteristics 29 and 31 there is an absolute difference value 33 caused by the fact that overall there is a higher temperature on both sides when the heating device 12 is switched on.

The characteristics 28 and 30 relate to a later time t at which the same gas temperature is intended to apply for the example illustrated here. It follows from this, however, that an offset drift 34 which was measured in a measurement with the heating device 12 switched off without heater, correspondingly also occurs for the characteristic 28 relative to the characteristic 29, as shown in FIG. 6.

Consequently, at the reference time t₀ with the heating device 12 switched off the inventive method is used in principle to measure the reference measured value 35 and store it, in particular in the storage device 23, or to use it directly, as is to be set forth in more detail below. If, at the later time t, a second measurement is carried out with the heating device 12 switched off, a drift measured value 36 results, a correction value at the level of the offset drift 34 resulting through subtraction of the reference measured value 35 from the drift measured value 36.

In a first, initially described embodiment, this correction value 34 can also be used to correct measured values M with the heating device 12 switched on by once again subtracting the correction value, and thus the offset drift 34, from an exemplary measured value 37, recorded with the heating device 12 in use, in accordance with the arrow 38, such that the corrected measured value 39 thus results on the characteristic 29. The correct throughflow value can now be read off.

A second measurement of the drift measured value 36 is now carried out at regular intervals, for example, every 30 minutes, in order to be able to track the correction value continuously in real time.

In order to determine the correction value it is advantageous in this case to consider, both for the reference measured value 35 and for the drift measured value 36, mean values of a plurality of consecutive measurements consideration being given in the case of the drift measured value 36 to a sliding mean value in the case of which, for example, it is always the last 64 measurements that are considered.

However, it is also possible for the measured values of the measurement variable to fluctuate nevertheless as a function of the gas temperature when the throughflow is the same. Although dependent in principle on the offset drift 34, this fluctuation can lead to errors in the correction and the calibration.

Consequently, in the inventive method there is provided a larger number of measurements in relation to the reference time in the case of which there are recorded respectively at different gas temperatures both reference measured values 35 with the heating device 12 switched off, and basic calibration values with the heating device 12 switched on and zero throughflow. The basic calibration values are used for the purpose of correctly using the characteristics combining the measurement variable with the throughflow all gas temperatures, in particular, given the presence of a zero crossing for zero throughflow. To this end, it is possible to derive as characteristic a functional dependence of the basic calibration value on the temperature (temperature function), but it is also conceivable to use lookup tables so that the basic calibration may be written as

M_{gk}=M_{m,T}−f_{Mn}(T)|_{Q=0}

where the measured value is denoted by M_{m,T}, when the heating device is switched on and gas temperature T, and with f_{Mn}(T)|_{Q=0} the temperature function for measured values Mₘ when the heating device 12 is switched on for throughflow Q=0.

However, the temperature is also to be observed when determining the correction value 34 so that the intention here is to use the correct reference value 35 for the temperature at which the measured value of the second measurement was recorded, which value is precisely to be used for subtraction. Here, as well, it is conceivable to derive a functional dependence on the reference measured value 35 for the temperature (temperature function) as characteristic, although lookup tables are also conceivable.

Denoted by M_{0,T} the measured value, recorded at the time of the second measurement, when the heating device 12 is switched off and gas temperature T, and by f_{M0}(T) the temperature function for reference measured values M₀ when the heating device 12 is switched off, independent of the throughflow Q, the completely corrected and calibrated measured value M_{base} of the measurement variable may be written as

M_{base}=M_{m,T}−f_{Mm}(T)|_{Q=0}(M_{0,T}−f_{M0}(T)).

The last term enclosed in brackets corresponds in this case to the correction value 34. Self-evidently, the measured values M_{m,T} and M_{0,T} were recorded at other times than the values determined at the reference time and on which the functions f are based. The current gas temperature T can always be measured in this case by the gas temperature sensor 19.

Thus, it is also possible to consider the temperature response of the temperature sensors 15a, 15b and/or measurement device 10.

It is also possible to conceive further embodiments, which are now to be briefly explained and for which the statements relating to the formation of mean values and the temperature response of the temperature sensors 15a, 15b and the measurement device 10 can be applied analogously, without this needing to be set forth once again.

In a second embodiment of the inventive method, it can be provided that the basic calibration value such as has been discussed above is modified so that it also includes the reference measured value 35. Consequently, if the original basic calibration value is understood as the measured value which is present in the case of a zero throughflow and measurement by using the heating device 12, the reference measured value 35 can be subtracted therefrom or added thereto. The basic calibration value thus modified is then subtracted in principle from each measured value 37 which is measured later and is to be corrected. However, it is additionally provided also to subtract the drift measured value 36 from the measured value 37 to be corrected, depending on the sign of the reference measured value 35 in the basic calibration value. The outcome of these calculation steps is a measured value corrected by the original basic calibration value and the difference between the reference measured value 35 and the drift measured value 36, that is to say the offset drift 34.

A third embodiment of the invention provides for the reference measured value 35 to be displayed, in particular in common with the basic calibration value, via a shift of the evaluation characteristics which then use as input datum the measured value 37 raised or lowered by the drift measured value 36 and recorded with the use of the heating device 12. Such a shifted evaluation characteristic 40, which runs in a linear fashion for the sake of simplicity in the example, is shown in FIG. 7. Owing to the shift by the basic calibration value and the reference measured value 35, a zero throughflow is indicated not by the value zero but by the value X. In order to keep the method robust against measurement uncertainties, a blocking region 41 was defined as running from X+Y to X−Y. Each measured value (corrected by the drift measured value 36) which is present as input value between X−Y and X+Y is assigned to a throughflow of zero.

1. A method for correcting offset drift effects of a thermal measurement device which comprises at least one temperature sensor arranged at a defined distance from a heating device for a fluid to be measured, for measuring at least one measurement variable describing the temperature and/or temperature profile during operation of the heating device, characterized in that a reference measured value is measured at a reference time in a first measurement of the measurement variable with the heating device turned off, in that a drift measured value is measured at at least one later time in a second measurement of the measurement variable with the heating device turned off, and in that a drift correction is carried out during the measurement by using the heating device on the basis of a difference between the drift measured value and the reference measured value.

2. The method as claimed in claim 1, wherein the measurement variable is determined by using an electronic module from signals of the temperature sensors.

3. The method as claimed in claim 1, wherein the second measurement is carried out cyclically at predetermined time intervals.

4. The method as claimed in claim 1, wherein during the correction use is made of a mean value of drift measured values recorded in the second measurements following one another in up to the last performed, second measurement.

5. The method as claimed in claim 1, wherein in order to calibrate the position of a characteristic diagram containing evaluation characteristics combining the measurement variable with an evaluation variable to be determined, at a first time a measurement is carried out with the use of the heating device in order to determine a basic calibration value to be subtracted from the measured values, or to be used to shift the evaluation characteristics in such a way that when measuring throughflow a zero crossing of the evaluation characteristic occurs at zero flow.

6. The method as claimed in claim 5, wherein at the first time which corresponds to the reference time and at which there is no throughflow and/or a clearly defined fluid type, a basic calibration value is determined for a measurement with the use of the heating device and a reference measured value is determined without the use of the heating device, this being done for at least two different fluid temperatures measured independently of the heating device by a fluidic temperature sensor, the plurality of reference measured values being taken into account for the correction in accordance with the temperature when the measured value is recorded.

7. The method as claimed in claim 6, wherein a temperature characteristic combining the basic calibration values and/or the reference measured values with the fluid temperature, and/or lookup table are/is determined and used to determine the basic calibration values and/or reference measured values and/or evaluation characteristics for a specific temperature.

8. The method as claimed in claim 1, wherein a correction value is determined from the difference between the drift measured value and the reference measured value and is subtracted from the measured value recorded with the use of the heating device.

9. The method as claimed in claim 5, wherein when determining said basic calibration value said value is modified by subtracting or adding the reference measured value, the drift measured value being added to the measured value, or the drift measured value being subtracted from the measured value for the purpose of correction.

10. The method as claimed in claim 1, wherein an evaluation characteristic used to assign the measurement variable to an evaluation variable is shifted by the reference measured value, the measured value shifted counter to the shift direction by the drift measured value being used as input value in order to determine an evaluation value.

11. The method as claimed in claim 10, wherein the evaluation characteristic is also shifted by the basic calibration value in the determination of a basic calibration value.

12. The method as claimed in claim 10, wherein a blocking region completely describing a zero throughflow is determined with the aid of the basic calibration value in the shifted evaluation characteristic in the case of a measurement variable describing the throughflow of the fluid through a measurement channel containing the measurement device.

13. The method as claimed in claim 1, wherein a microthermal measurement device is used as measurement device, and/or at least one thermocouple is used as temperature sensor.

14. The method as claimed in claim 1, wherein a measurement variable describing the throughflow of the fluid through a measurement channel containing the measurement device is measured as measurement variable, at least one temperature sensor being provided in a throughflow direction of the fluid on both sides of the heating device at an equal distance from the heating device, and a difference between sensor signals of the two temperature sensors is used as measurement variable.

15. The method as claimed in claim 1, wherein a measurement variable representing a static state of equilibrium, describing the thermal conductivity of the fluid, is measured as measurement variable after activation of the heating device and is used to determine a fluid type.

16. The method as claimed in claim 1, wherein the thermal measurement device is installed in a gas flow meter.

17. A thermal measurement device comprising a heating device, at least one temperature sensor arranged at a defined distance from the heating device for a fluid to be measured, for measuring at least one measurement variable describing the temperature and/or temperature profile during operation of the heating device and a control device which is designed to carry out a method as claimed in claim 1.

18. A gas flow meter comprising a thermal measurement device as claimed in claim 17.

19. The method as claimed in claim 2, wherein said electronic module comprises an amplifier and/or an analog-to-digital converter for digitizing the measurement variable.

20. The method as claimed in claim 3, wherein said predetermined time intervals are in the range from every 5 minutes to every 24 hours.

21. The method as claimed in claim 4, wherein said mean value and/or a mean value from 30 to 80 individual drift measured values.

22. The method as claimed in claim 13, wherein said microthermal measurement device is implemented on a chip.

23. The method as claimed in claim 13, wherein said at least one thermocouple is a number of series-connected thermocouples equally spaced from the heating device.

24. The method as claimed in claim 16, wherein said gas flow meter is a gas meter.
